(19) United States
(12) Patent Application Publication
(10) Pub. No.: US 2026/0264573 A1
(43) Pub. Date: Sep. 10, 2026

(54) FUEL CELL SYSTEM AND METHOD OF OPERATING THE FUEL CELL SYSTEM

(71) Applicant: VOLVO TRUCK CORPORATION, Göteborg (SE)

(72) Inventors: Pranav ARYA, Lindome (SE); Ricard BLANC, Mölndal (SE)

(73) Assignee: VOLVO TRUCK CORPORATION, Göteborg (SE)

(21) Appl. No.: 19/166,333

(22) PCT Filed: Mar. 20, 2023
(86) PCT No.: PCT/EP2023/057105

§ 371 Date: Sep. 17, 2025

(51) Int. Cl. B60L 58/33; B60L 50/70; H01M 8/04223; H01M 8/04228; H01M 8/04303; H01M 8/0432; H01M 8/04701; H01M 8/04955

(52) U.S. Cl. CPC B60L 58/33; B60L 50/70; H01M 8/04228; H01M 8/04253; H01M 8/04303; H01M 8/0432; H01M 8/04701; H01M 8/04955; B60L 2200/36; B60L 2240/36; B60L 2260/58; H01M 2250/20

(57) ABSTRACT

A fuel cell vehicle has a fuel cell system and a control system with processing circuitry to control operation of a fuel cell system. The processing circuitry is configured to estimate a duration of a stopover of the vehicle when a request for the stopover/parking of the vehicle is detected; determine whether the fuel cell system needs to be shut down during the stopover; responsive to determining that the fuel cell system needs to be shut down during the stopover and responsive to determining that a freeze preparation of the fuel cell system is required during the stopover; and, responsive to determining that it is possible to reduce the temperature of the fuel cell system below a first threshold level at the time of the shutdown of the fuel cell system, perform an early freeze preparation at the time of the shutdown of the fuel cell system.

### TECHNICAL FIELD

The disclosure relates generally to operating a fuel cell system in a fuel cell vehicle. In particular, the disclosure relates to selectively performing a freeze preparation of the fuel cell system during a stopover of the vehicle.

The disclosure can be applied in heavy-duty vehicles, such as trucks, buses, and construction equipment. Although the disclosure may be described with respect to a particular vehicle, the disclosure is not restricted to any particular vehicle.

### BACKGROUND

In a fuel cell vehicle, one or more fuel cell systems, typically in combination with an electrical energy storage system such as batteries, are used for powering the vehicle. The fuel cell system comprises one or more, and typically hundreds of fuel cells forming a fuel cell stack for generating the desired propulsion power supplied to the vehicle. A fuel cell is an electrochemical device that includes an electrolyte sandwiched between two electrodes such as an anode and a cathode. The fuel cell converts the chemical energy of a fuel, typically hydrogen, and an oxidizing agent, typically oxygen or air, into electricity. Fuel cells are increasingly considered for powering electric vehicles, such as pure electric vehicles and hybrid electric vehicles.

Fuel cell systems may be subjected to repeated on-off duty cycles involving periods of inactivity (e.g., storage or off-duty conditions) for varied lengths of time and at varied temperatures. It is generally desirable to be able to reliably start-up fuel cells in a short period of time. For example, automotive applications may require a sufficiently fast, reliable start-up from a shut-down state at below zero environmental temperatures. At the same time, fuel cell systems are quite sensitive to cold temperatures. Thus, even below freezing temperatures of under 0° C. may cause damage to a fuel cell system, particularly during the system start-up.

Various methods have been proposed for storing and starting-up fuel cells in anticipation of below freezing ambient conditions. For example, a freeze preparation may be performed by expelling or purging water from inside a fuel cell system, so as to prevent any freezing and thus damage inside the system.

However, despite current developments, there remains a need in improved methods for appropriate managing of fuel cell systems in below-zero temperature conditions and in anticipation of such conditions.

### SUMMARY

According to an aspect of the disclosure, a fuel cell vehicle is provided that comprises a fuel cell system comprising an anode, a cathode, and a cooling subsystem. The fuel cell vehicle also comprises a control system comprising processing circuitry configured to control operation of a fuel cell system, the processing circuitry being configured to:
estimate a duration of a stopover of the vehicle when a request for the stopover of the vehicle is detected;
determine whether the fuel cell system needs to be shut down during the stopover, wherein the determining is based at least on the duration of the stopover of the vehicle;
responsive to determining that the fuel cell system needs to be shut down during the stopover and responsive to determining that a freeze preparation of the fuel cell system is required during the stopover, determine whether it is possible to reduce a temperature of the fuel cell system below a first threshold level at a time of a shutdown of the fuel cell system; and
responsive to determining that it is possible to reduce the temperature of the fuel cell system below the first threshold level at the time of the shutdown of the fuel cell system, perform an early freeze preparation at the time of the shutdown of the fuel cell system.

Thus, if a freeze preparation is required, the freeze preparation may be performed earlier, at a time of the shutdown of the fuel cell system, such that there is no need to keep a control system of the fuel cell system fully activated. The control system may be a fuel cell controller configured to control operation of the fuel cell system, a vehicle controller or system configured to control operation of various components of the vehicle, or any other control system such as e.g. a control system configured to perform one or more functions of the fuel cell controller and one or more functions of the vehicle control system. A technical benefit of avoiding a need to keep all functions of the control system up and running includes saving energy and thus operating the fuel cell system, and the entire vehicle, in a more cost-effective manner. Also, the freeze preparation may be performed in a more controlled manner. In addition, performing the freeze preparation of the fuel cell system requires having operational at least some other components of a high-voltage (HV) system of the vehicle, in addition to the fuel cell system. This also requires energy resources. The methods and systems of the present disclosure allow further saving energy by deactivating or not activating certain components of the vehicle such as the HV system.

In some examples, the processing circuitry of the control system is further configured to control operation of the fuel cell system such that the performing of the freeze preparation at the time of the shutdown of the fuel cell system comprises performing the shutdown of the fuel cell system, reducing the temperature of the fuel cell system below the first threshold level, and performing the freeze preparation.

In some examples, the fuel cell vehicle comprises a vehicle control system configured to control operation of the fuel cell vehicle. In some examples, the control system and the vehicle control system may be part of a same control system.

In some examples, the processing circuitry of the control system is further configured to at least partially deactivate a monitoring unit of the control system and and/or at least partially deactivate a monitoring unit of the vehicle control system of the fuel cell vehicle.

In some examples, the temperature of the fuel cell system is reduced below the first threshold level using a cooling subsystem of the fuel cell system.

In some examples, the processing circuitry of the control system is further configured to control operation of the fuel cell system by, responsive to determining that it is not possible to reduce the temperature of the fuel cell system below the first threshold level at the time of the shutdown, performing the shutdown of the fuel cell system without performing a freeze preparation.

In some examples, the processing circuitry of the control system is further configured to:
monitor an ambient temperature and a temperature of the fuel cell system, with the fuel cell system being shut down;
determine, based on the monitoring, whether the temperature of the fuel cell system is below a third threshold level; and
responsive to determining that the temperature of the fuel cell system is below the third threshold level,
perform a wake-up of the fuel cell system, and
perform the freeze preparation after the wake-up of the fuel cell system.

In some examples, the processing circuitry of the control system is further configured to determine the duration of the stopover of the vehicle based on one or more out of a location of the vehicle, historical data on operation of the vehicle, and input from a driver of the vehicle.

In some examples, the processing circuitry of the control system is configured to determine whether a freeze preparation of the fuel cell system is required or not based on a predicted and/or current ambient temperature and/or a thermal model of the fuel cell system.

In some examples, the processing circuitry of the control system is further configured to determine whether it is possible to reduce a temperature of the fuel cell system below the first threshold level during the stopover based on a predicted and/or current ambient temperature and/or a thermal model of the fuel cell system.

In some examples, the processing circuitry of the control system is further configured to determine whether it is possible to reduce a temperature of the fuel cell system below the first threshold level during the stopover by determining whether the ambient temperature is below a second threshold level.

According to an aspect of the disclosure, a method of controlling operation of a fuel cell system of a fuel cell vehicle is provided, the method comprising:
estimating a duration of a stopover of the vehicle when a request for the stopover of the vehicle is detected;
determining whether the fuel cell system needs to be shut down during the stopover, wherein the determining is based at least on the duration of the stopover of the vehicle;
responsive to determining that the fuel cell system needs to be shut down during the stopover and responsive to determining that a freeze preparation of the fuel cell system is required during the stopover, determining whether it is possible to reduce a temperature of the fuel cell system below a first threshold level at a time of a shutdown of the fuel cell system; and
responsive to determining that it is possible to reduce the temperature of the fuel cell system below the first threshold level at the time of the shutdown of the fuel cell system, performing an early freeze preparation at the time of the shutdown of the fuel cell system.

In some examples, performing the freeze preparation at the time of the shutdown of the fuel cell system comprises performing the shutdown of the fuel cell system, reducing the temperature of the fuel cell system below the first threshold level, and performing the freeze preparation.

In some examples, the method further comprises at least partially deactivating a monitoring unit of the control system and/or at least partially deactivating a monitoring unit of a vehicle control system of the fuel cell vehicle.

In some examples, the temperature of the fuel cell system is reduced below the first threshold level using the cooling subsystem of the fuel cell system.

In some examples, the method further comprises, responsive to determining that it is not possible to reduce the temperature of the fuel cell system below the first threshold level at the time of the shutdown, performing the shutdown of the fuel cell system without performing a freeze preparation.

In some examples, the method further comprises:
monitoring an ambient temperature and a temperature of the fuel cell system, with the fuel cell system being shut down;
determining, based on the monitoring, whether the temperature of the fuel cell system is below a third threshold level; and
responsive to determining that the temperature of the fuel cell system is below the third threshold level,
performing a wake-up of the fuel cell system, and
performing the freeze preparation after the wake-up of the fuel cell system.

In some examples, the duration of the stopover is determined based on one or more out of a location of the vehicle, historical data on operation of the vehicle, and input from a driver of the vehicle.

In some examples, the method further comprises determining whether a freeze preparation of the fuel cell system is required or not, based on a predicted and/or current ambient temperature and/or a thermal model of the fuel cell system.

In some examples, the determining whether it is possible to reduce a temperature of the fuel cell system below the first threshold level during the stopover is based on a predicted and/or current ambient temperature and/or a thermal model of the fuel cell system.

In some examples, the method comprises determining whether it is possible to reduce a temperature of the fuel cell system below the first threshold level during the stopover by determining whether the ambient temperature is below a second threshold level.

In some examples, the method further comprises, responsive to determining that the fuel cell system does not need to be shut down during the stopover, continuing operating the fuel cell system.

In some examples, the method further comprises, responsive to determining that the fuel cell system needs to be shut down during the stopover and responsive to determining that the freeze preparation of the fuel cell system is not required during the stopover, shutting down the fuel cell system.

In some examples, the method further comprises at least partially deactivating a monitoring unit of the a control system of the fuel cell system and/or at least partially deactivating a monitoring unit of a vehicle control system of the fuel cell vehicle.

According to an aspect of the disclosure, a control system is provided for controlling the fuel cell system of the fuel cell vehicle, the control system comprising processing circuitry that is configured to perform the method in accordance with examples of the present disclosure.

According to an aspect of the disclosure, a fuel cell system comprising the control system is provided, the control system comprising processing circuitry that is configured to perform the method in accordance with examples of the present disclosure.

According to an aspect of the disclosure, a fuel cell system in communication with the control system is provided, the control system comprising processing circuitry that is configured to perform the method in accordance with examples of the present disclosure.

According to an aspect of the disclosure, a computer program product comprising instructions, which, when executed by processing circuitry, cause the processing circuitry to perform the method in accordance with examples of the present disclosure.

According to an aspect of the disclosure, a computer-readable storage medium is provided. The computer-readable storage medium has stored thereon a computer program product comprising instructions which, when executed by processing circuitry, cause the processing circuitry to perform the method in accordance with examples of the present disclosure.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control systems, units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1A is a side view of an example of a vehicle comprising a fuel cell system in accordance with an example of the present disclosure.

FIG. 1B is a block diagram illustrating another example of a vehicle in accordance with an example of the present disclosure.

FIG. 2A is a block diagram illustrating a fuel cell system and one or more control systems in accordance with an example of the present disclosure.

FIG. 2B is a block diagram illustrating an example of a cooling subsystem for cooling a fuel cell system in accordance with an example of the present disclosure.

FIG. 3 is a flowchart illustrating an example of a method of operating a fuel cell system, in accordance with an example of the present disclosure.

FIG. 4A is another flowchart illustrating an example of a method of operating a fuel cell system, in accordance with an example of the present disclosure.

FIGS. 4B and 4C are flowcharts further illustrating an example of the method of operating the fuel cell system of FIG. 4A, in accordance with an example of the present disclosure.

FIGS. 5A and 5B are block diagrams illustrating an example of a control system for controlling operation of a fuel cell system, in accordance with aspects of the present disclosure.

### DETAILED DESCRIPTION

Aspects set forth below represent the necessary information to enable those skilled in the art to practice the disclosure.

In cases when a vehicle such as e.g. a fuel cell electric vehicle (FCEV) is stopped for a certain duration of time, e.g., parked, at a certain location, the fuel cell system of the vehicle may be shut down. Fuel cell systems included, for example, in FCEVs, are quite sensitive to cold temperatures and generally need to be prepared in anticipation of below-freezing conditions and/or prepared for a freeze start-up that is a fuel cell system start-up at cold, such as freezing or below-freezing, conditions. A fuel cell system may be prepared for current or possible future cold conditions by, for example, expelling water from inside a fuel cell stack of the fuel cell system, so as to prevent any water freezing in the fuel cell system which may cause sever, often irreparable damage. At the same time, a freeze preparation procedure, particularly if performed frequently, may cause damage and degradation of the fuel cell system.

If a freeze preparation procedure is performed without then shortly waking up the fuel cell system, there may still be some water undesirably left in the fuel cell system as all the water may not have condensed after hot operation of the fuel cell system. On the other hand, depending on a freeze preparation strategy, if a freeze preparation is performed at a later time, e.g., after waking up suitable components of the vehicle several hours or later after the fuel cell system shutdown, this can lead to an air-to-air start or even result in a fuel cell stack being at open circuit voltages for extended durations, which causes degradation of the fuel cell stack.

Thus, it is desirable to perform a freeze preparation of the fuel cell system less frequently and when ambient temperatures are below a certain level. If the conditions at the fuel cell system shutdown are not suitable for performing a freeze preparation, a control system of the vehicle may monitor the current conditions to check if they have changed and are suitable for performing the freeze preparation. This however requires the control system and other components of the vehicle, e.g., a controller of the fuel cell system, to be up and running to continuously monitor the current conditions and thereby determine if the conditions become appropriate to perform the freeze preparation. Such monitoring consumes energy/power of the vehicle during the vehicle stopover/parking.

Furthermore, generally, a fuel cell system shutdown may not always be required. Also, even if the fuel cell system is shut down, it may be that the fuel cell system does not need to be subjected to a freeze preparation, and/or that the performance of the freeze preparation is not possible. The freeze preparation may not be an energy-efficient option given current circumstances.

Accordingly, the system and method herein allow, based at least on parameters such as a predicted and/or current ambient temperature and a duration of the vehicle stopover, determining whether a freeze preparation of the fuel cell system is required or not and, if it is required, performing the freeze preparation earlier at a time of shutting down the fuel cell system. In this way, certain functions of the one or more control systems of the vehicle do not need to be kept operational once the freeze preparation has been performed, thereby energy and thus costs of operating the fuel cell system and the vehicle are advantageously reduced.

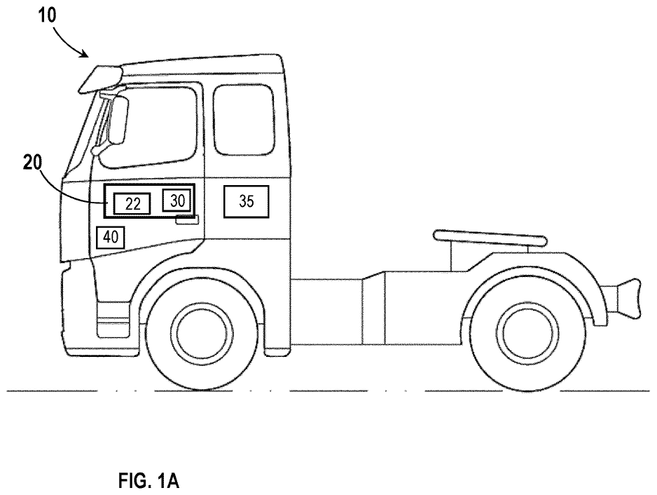

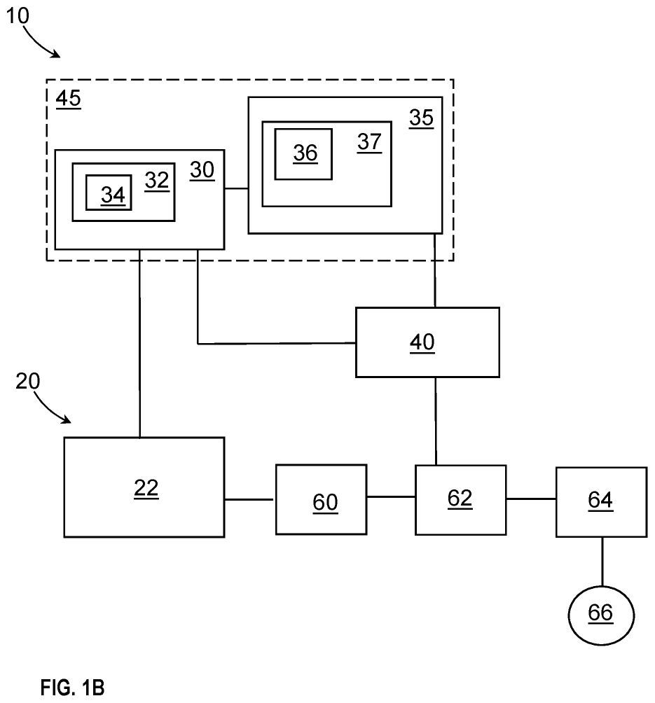

FIG. 1A is a side view of an example of a vehicle 10 in which some examples in accordance with the present disclosure may be implemented. The vehicle 10 is shown as a truck, such as a heavy-duty truck for towing one or more trailers (not shown). The vehicle 10 may be a fuel cell electric vehicle (FCEV) or a hybrid vehicle. It should however be appreciated that the present disclosure is not limited to this, or any other specific type of a fuel cell vehicle, and may be used in any other type of vehicle, such as a bus, a construction equipment vehicle, a passenger car, etc.

As shown schematically in FIG. 1A, the vehicle 10 comprises a fuel cell system 20 which may be used for powering one or more electric machines or motors (not shown) which are used for creating a propulsion force to the vehicle 10. The vehicle 10 comprises a high voltage (HV) system including components such as a fuel cell system 20 comprising a fuel cell stack 22, a fuel cell controller or control system 30, an electrical storage system (ESS) 40, and various other components, such as a power inverter, electric machines, a charger, a DC-DC converter, an air conditioning compressor, an electric heating system, etc. As shown in FIG. 1A, the vehicle 10 comprises a vehicle controller or control system 35 configured to control operation of various components of the HV system of vehicle 10, including the fuel cell system 20. The vehicle control system 35 may perform functions of a power controller configured to control power electronics of the vehicle 10, and the vehicle control system 35 may control other functions in the vehicle. Some of the components of the HV system may have their own controllers or some components may share controllers, and the vehicle control system 35 is shown by way of example.

The fuel cell controller or control system 30 is configured to control operation of the fuel cell system 20. The vehicle control system 35 may be electrically coupled to the control system 30 such that the vehicle control system 35 and the fuel cell controller/control system 30 may communicate regarding operation of the fuel cell system 20 and other components of the vehicle. For example, the vehicle control system 35 may send control signals to the control system 30. A freeze preparation of the vehicle may require waking up some components of the HV system of the vehicle 10, as well as waking up the fuel cell system 20.

In some examples, the vehicle control system 35 may perform some or all functions of the control system 30. Thus, in some examples, the vehicle control system 35 may include processing circuitry configured to perform functions of the control system 30, such that the control system 30 is part of the vehicle control system 35. Furthermore, in some examples, some functions related to control of operation of the fuel cell system and its maintenance, including a freeze preparation, may be performed by either the control system 30 or the vehicle control system 35. Some functions can be interchanged between vehicle and fuel cell system controllers, such that some functions related to operation of the fuel cell system 20 can be performed by processing circuitry of the vehicle control system 35, and some functions related to operation of other components of the vehicle 10 can be performed by processing circuitry of the fuel cell control system 30.

The fuel cell system 20 comprises one or more, typically multiple, fuel cells which together form the fuel cell stack 22. The fuel cell system 20 may include one or more fuel cell stacks. Also, the fuel cell system 20 may comprise one or more fuel cell systems, such that the vehicle 10 may have multiple fuel cell systems, e.g., two or more fuel cell systems.

As shown in FIG. 1A, the vehicle may comprise the electric energy storage (ESS) 40 such as e.g. one or more batteries, one or more supercapacitors, or a combination of one or more batteries and one or more supercapacitors. The ESS 40 is rechargeable and is adapted and configured to store electrical energy, including excess electric produced by the fuel cell system 20. The ESS 40 may store energy regenerated during braking such as regenerative braking, and/or it may be configured for charging by a charger, such as, e.g., from an external power grid. The ESS 40 is configured to assist the fuel cell system in supplying energy to the drive motor, to meet power/energy demands of the vehicle 10. The ESS 40 may be configured to provide additional propulsive power in situations when the complete required power cannot be provided by fuel cell system 20, or when it is not suitable to provide the complete required power by the fuel cell system 20. In various examples, the ESS 40 may provide electrical energy storage during regenerative braking, provide electrical energy storage device for electrical energy that is generated from a fuel cell system at low loads, assists the fuel cell system 20 with generating power at higher loads, or may serve as a main energy supplier in some circumstances.

The fuel cell system 20 and the ESS 40 can provide power to other electric power consumers (not shown) of the vehicle 10, such as an electric motor for a crane, an electric motor for a refrigerator system, an electric motor for a concrete mixing system, an electric motor for an air conditioning system, or any other electric power consuming function of the vehicle 10. The vehicle 10 may be powered using electrical energy from any combination of the fuel cell system 20 and the ESS 40.

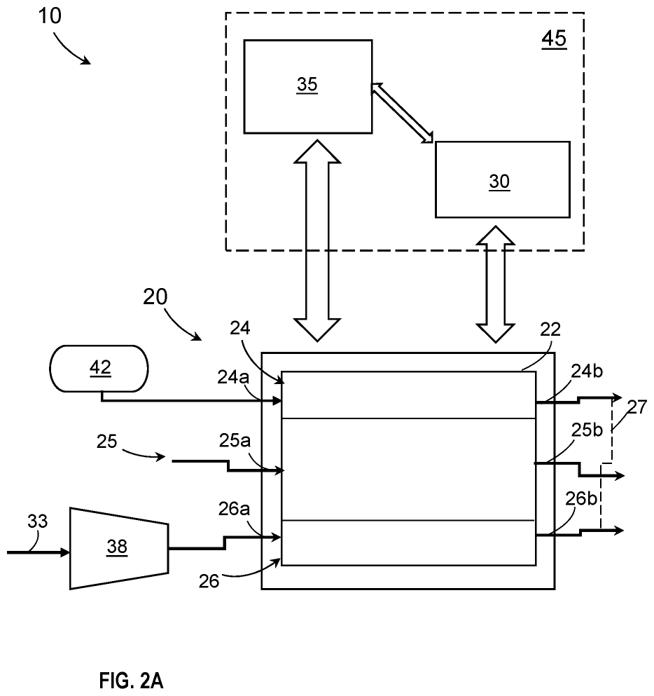

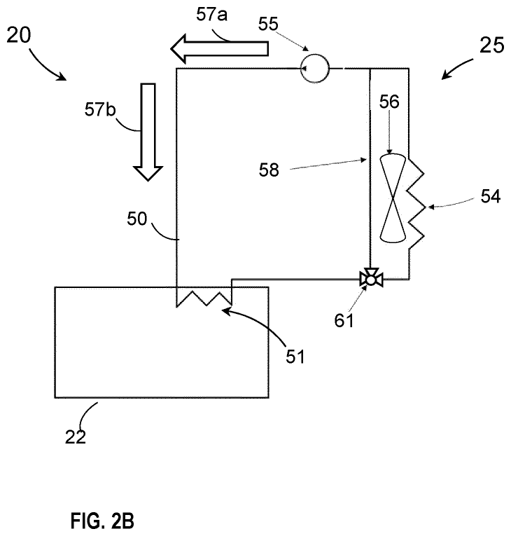

The fuel cell system 20 is configured to provide the fuel cells with necessary supply of hydrogen fuel (H₂) and oxidizer such as air or oxygen, as well as with cooling, humidification, etc. The fuel cell system 20 may include various components, some of which are shown in FIGS. 1B, 2A and 2B discussed below.

The fuel cell system 20 may comprise multiple fuel cell systems, and each fuel cell system may comprise its own control system, which may be communicatively connected to a controller or control system. The fuel cell system 20 may comprise a single fuel cell system, two fuel cell systems, or more than two fuel cell systems, such as three or more fuel cell systems. Furthermore, when several fuel cell units or systems are provided, the fuel cell systems may be either independently controllable or commonly controllable. When independently controllable, each fuel cell system may be controlled to an on-state or an off-state regardless of the state(s) of the other fuel cell system(s). When two or more of the fuel cell systems are commonly controllable, those fuel cell systems are controllable in common to an on-state or an off-state, i.e., all fuel cell systems are controlled in common to the same state. Two fuel cell systems may in some cases be controlled in dependence on one another, such that one of the fuel cell systems is controlled to an on-state or an off-state in dependence on the state of the other fuel cell system(s).

The fuel cell system controller or control system 30 of the vehicle 10 comprises one or more units, according to an example of the present disclosure. The control system 30 is configured to control operation of subsystems of the fuel cell system 20, as discussed in more detail below. The fuel cell system 20 may be communicatively coupled to the control system 30. In the example of FIG. 1A, the fuel cell system 20 is shown to include the control system 30, but the control system 30 may be a component that is separate from the fuel cell system 20 and that is communicatively coupled to the fuel cell system 20. In some examples, the control system 30 may be part of the vehicle control system 35. In implementations (not shown) in which the fuel cell system 20 comprises multiple fuel cell systems, each fuel cell system may comprise its own control system. In some implementations, a control system may control operation of multiple control systems.

Even though an on-board control system 30 is shown in FIG. 1A, it should be understood that the control system 30 may be a remote control system, i.e. an off-board control system, or a combination of an on-board and off-board control system(s). The control system 30 may be configured to control the fuel cell system 20 by issuing control signals and by receiving status information relating to the fuel cell system 20 and its components. The control system 30 may be configured to receive information from various sensors, including one or more of pressure sensors, temperature sensors, moisture sensors, and other sensors included in or associated with the fuel cell system 20 and/or the vehicle 10. For example, an ambient temperature sensor may be positioned such that it can measure an ambient temperature, such as a temperature outside and/or in the vicinity of the vehicle, that reflects a temperature to which the fuel cell system 20 is subjected. Various sensors may acquire measurements regarding internal operation of the fuel cell system 20. Thus, a temperature sensor for monitoring a temperature of the fuel cell stack of the fuel cell system 20 may be positioned in the stack or in the vicinity in the stack, i.e. in a location at which a measured temperature reflects the temperature of the fuel cell stack.

The control system 30 may be communicatively coupled to an internal database, an external database, or a combination of internal and external databases, to receive historical data on the vehicle operation; historical data related to driver's driving pattern and a pattern of operation of the vehicle; historical data on frequency, locations, and durations of stops along routes traveled by the vehicle in the past; historical data on ambient conditions at the locations traveled by the vehicle; historical data on missions or tasks performed by the vehicle, including a schedule of the tasks and related routes, etc.

The control system 30 may communicate with various external data providers, e.g., weather services or servers, Global Positioning System (GPS) servers, Global Navigation Satellite System (GNSS) servers, map servers, and/or any other servers and/or services from which information useful for methods herein may be obtained. The control system 30 may receive data from a weather service which may include data on actual and predicted weather conditions, and other types of data. The data on weather conditions, such as actual and/or predicted weather conditions, may include data on as a temperature e.g. at a vehicle's current location, altitude, humidity, and wind speeds. Also, the control system 30 may be aware of specifics of a location in which the vehicle is stopped, such as e.g. whether the vehicle is parked indoors or outdoors, typical e.g. historic ambient temperatures and their variation at that geographical location, a typical time of a vehicle stop at that location, etc.

The control system 30 may be an electronic control unit and may comprise processing circuitry which is adapted to execute a computer program code or computer-executable instructions to perform a method in accordance with some examples. The control system 30 may comprise hardware, firmware, and/or software for performing methods according to examples of the present disclosure. The control system 30 may be denoted a computer. The control system 30 may be constituted by one or more separate sub-control units. In addition, the control system 30 may communicate by use of wired and/or wireless communication technology.

FIG. 1B further illustrates an example of some components of the HV system of the vehicle 10 in accordance with an example of the present disclosure. The vehicle 10 comprises the fuel cell stack 22 of the fuel cell system 20, the ESS 40 such as e.g. one or more batteries and/or one or more supercapacitors, a DC/DC converter 60, a junction box or unit 62, an electric motor or electric machine 64, and wheels 66. The vehicle 10 also comprises the fuel cell system controller/control system 30 and the vehicle controller 35. In some examples, the fuel cell system controller 30 and the vehicle controller 35 may be part of the same control system 45 as shown by a dashed line in FIG. 1B.

Electric power generated by the fuel cell stack 22 is supplied to the junction box or unit 62, such as e.g. a high-voltage junction box, through the DC/DC converter 60 that converts and stabilizes the voltage. The power is supplied, via the junction unit 62, to the electric machine 64 for providing propulsion power to the wheels 66 of the vehicle 10. The junction unit 62 is a component that serves as a meeting spot for electrical connections between the fuel cell stack 22, the ESS 40, and the electric machine 64. Traction power to the wheels 66 is delivered by the electric machine 64 supplied by one or both the fuel cell stack 22 and the ESS 40. The vehicle 10 may comprise other components such as e.g. inverters, various other controllers, etc.

As shown in FIG. 1B, the fuel cell system controller/control system 30 may comprise a processing circuitry 32 comprising a monitoring unit 34 that is configured to acquire sensor and other measurements and performs other processing related to operation of the fuel cell system. The processing circuitry 32 may be configured to execute computer-executable instructions stored in memory of the control system 30, to perform functions of the control system 30.

The monitoring unit 34, which may encompass more than one units, may be controlled to be in one of an activated mode, a deactivated mode, or a partially activated/deactivated mode. In the activated mode, the monitoring unit 34 is operated to acquire and process sensor measurements, and can activate the fuel cell system 20 to perform a freeze preparation. In some cases, the monitoring unit 34 may be configured to selectively operate in more than one mode, e.g., it can also be operated in a partially activated/deactivated mode in which some of its functions are activated and some are deactivated. When the monitoring unit 34 is operating during a stopover of the vehicle, the unit 34 monitors a status or conditions at the fuel cell system 20 to determine whether to wake-up the fuel cell system 20, to perform a freeze preparation. In the deactivated mode, or in a partially activated mode, of the monitoring unit 34, e.g., during a stopover of the vehicle 10 when no monitoring of the fuel cell system 20 is required or only partial monitoring of the fuel cell system 20 is performed, energy costs may be saved. In some examples, it is advantageously determined whether the monitoring unit 34 needs to be in the activated mode or whether it can be switched to the deactivated mode or partially activated mode to thereby increase energy savings.

As also shown in FIG. 1B, the vehicle control system 35, configured to control operation of various components of the vehicle 10, comprises processing circuitry 37 such as one or more processors. The processing circuitry 37 may be configured to execute computer-executable instructions stored in memory of the vehicle control system 35, to perform functions of the vehicle control system 35. The processing circuitry 37 may comprise a monitoring unit 36 that is configured to acquire sensor and other measurements and to perform other processing related to operation of the vehicle 10. The monitoring unit 36 of the vehicle control system 35 may be controlled to operate in one of an activated mode, a deactivated mode, or in a partially activated/deactivated mode in which some of its functions are activated and some are deactivated. In some cases, certain functions of the monitoring unit 36 are always turned on during a lifetime of the vehicle 10. Depending on the configuration and operating mode of the monitoring unit 36, the processing circuitry 37 of the vehicle control system 35 may control components of the vehicle 10 to be turned on or off, or to be idling, including during the stopover/parking of the vehicle.

The monitoring unit 36 is configured to, during the stopover of the vehicle 10, monitor various components of the vehicle 10 and to control one or more components to be deactivated or activated/woken up during the stopover, e.g., to perform a freeze preparation of the fuel cell system 20. In the deactivated mode or in the partially activated/deactivated mode of the monitoring unit 36, energy costs of operating the vehicle 10 may be saved. Furthermore, because at least some of the components of the vehicle 10 and the fuel cell system 20 are not operating during the vehicle stopover, these leads to energy savings. When the freeze preparation of the fuel cell system is performed at the time of the shutdown of the fuel cell system, temperature and other sensors may not be operating while the fuel cell system is shut down, and energy costs related to keeping these sensors operational may thus be decreased.

The fuel cell system controller 30 and the vehicle control system 35 may comprise other units for controlling, by processing circuitry, operation of the fuel cell system 20 and other components of the vehicle 10.

In some examples, as shown in FIG. 1B, the fuel cell system controller 30 and the vehicle controller 35 may be part of the same control system 45. The control system 45, which may be a main vehicle controller, may comprise processing circuitry (not shown) that is configured to perform some or all of the functions of the processing circuitry 32 of the fuel cell system controller/control system 30 and/or of the processing circuitry 37 of the vehicle control system 35. The control system 45 may comprise various units, including a monitoring unit (not shown) similar to the monitoring unit 34 of the fuel cell system controller/control system 30 and the monitoring unit 36 of the vehicle control system 35.

In some examples, after the freeze preparation of the fuel cell system 20 is performed, some of the functions of the control system 45, e.g., the function related to monitoring a state of the fuel cell system 20, are deactivated such that energy may be saved during the vehicle parking. Furthermore, some of the function of the vehicle 10 itself, e.g. of its components, may be deactivated which thereby also contributes to energy saving. In some cases, energy savings may be from a few hundreds of watt-hour (Wh) to a few kWh.

FIGS. 2A and 2B illustrate an example of components of the vehicle 10, including the fuel cell system 20, in which methods in accordance with aspects of the present disclosure may be implemented. As depicted in FIG. 2A, the vehicle 10 comprises the fuel cell system 20 comprising a fuel cell stack 22 comprising multiple fuel cells (not shown). Operation of the fuel cell system 20 is controlled by one or more control devices or systems, such as one or more out of the fuel cell controller/control system 30, the vehicle control system 35, and the control system 45. The control system 45, which may be referred to as a main control system of the vehicle 10, may be configured to perform functions of the fuel cell controller 30 and the vehicle control system 35, as well as other suitable monitoring and control functions. In some examples, the control system 45 may be a vehicle controller.

In the fuel cell stack 22, an electrolyte, such as e.g. a polymer electrolyte membrane (PEM) (not shown), is sandwiched between two electrodes or catalyst layers—an anode or anode side 24 and a cathode or cathode side 26. The vehicle 10, e.g., the fuel cell system 20, includes a coolant side or cooling subsystem 25, schematically shown in FIG. 2A and illustrated further in FIG. 2B, that is configured to control and/or regulate a temperature of the fuel cell system 20. It should be noted that the anode side 24, cooling subsystem 25, and cathode side 26 are shown schematically, without indicating their boundaries or details of their configuration. A person of skill in the art would understand how to implement these elements.

As shown in FIG. 2A, the anode side 24 has an anode inlet 24a and an anode outlet 24b, the cathode side 26 has a cathode inlet 26a and a cathode outlet 26b, and the cooling subsystem 25 has a coolant inlet 25a and a coolant outlet 25b. It should be noted that the respective inlets and outlets are shown by way of example only, as the anode 24, cathode 26, and the cooling subsystem 25 may be implemented in various ways. Furthermore, the cooling subsystem 25 may be implemented as a closed-loop circuit. Also, an output flow, such as by-product water, discharged from the cathode outlet 26b may in some implementations be reused, at least in part, in the fuel cell system 20.

As shown by an arrow 33 in FIG. 2A, air from the outside environment, e.g. an ambient air, is supplied to a compressor 38 that pressurizes the air, thereby a compressed air is created and supplied to the cathode 26 via the cathode inlet 26a. The air may also be filtered before entering the compressor 38. Also, before being supplied to the cathode 26, the air may be cooled and humidified.

In the example shown in FIG. 2A, the fuel cell system 20 is shown to comprise a fuel storage device 42 such as one or more hydrogen storage containers or tanks fluidly connected to the anode 24, such that hydrogen is supplied to the anode 24. The fuel storage device 42 may have any suitable configuration. In some embodiments, the fuel cell system 20 may alternatively or additionally receive hydrogen fuel from a source device configured to generate hydrogen.

A cathode output flow of the cathode 26 passes through the cathode outlet 26b, possibly through other components, to the outside i.e. atmosphere. In some cases, the output flow, comprising byproducts of the electrochemical reaction in the fuel cell stack 22 that generates electrical energy, is reused at least in part in the fuel cell system 20 and/or in the vehicle 10. As shown in FIG. 2A by way of example, an anode output flow of the anode 24 exits the fuel cell stack 22 through the anode outlet 24b and can also be expelled to the outside of the fuel cell system 20. In some examples, as shown in FIG. 2A by a dashed line 27, the anode output flow may be combined with the cathode output flow such that the out flows combined contents, or an exhaust flow, are expelled to the outside, and/or reused.

The cooling subsystem 25 is used to control a temperature of the fuel cell stack 22 during operation of the stack. The cooling subsystem 25 may have a suitable configuration that allows a coolant, e.g. water, air, and/or other medium, to be circulated to reduce a temperature of the fuel cell system 20, e.g. the fuel cell stack 22 and other components of the fuel cell system 20.

FIG. 2B illustrates an example of the cooling subsystem 25 of the fuel cell system 20. In examples herein, the cooling subsystem 25 is configured to control a temperature of the fuel cell stack 22 during operation and to cool down the fuel cell stack 22 when the fuel cell system 20 is shut down. The cooling subsystem 25 may be implemented as a coolant circulating circuit in the form of a loop 50 comprising a conduit, or a series of conduits, in which a coolant pump 55 circulates a suitable coolant. The pump 55 comprises or is coupled to an electric motor (not shown) which is controlled to thereby control the flow of the coolant through the coolant circulating circuit 50. For example, a controller, such as the control system 30 may be configured to control the operation of the coolant pump 55, as well as other components of the coolant subsystem 25 of the fuel cell system 20. The control system 30 may be configured to control activation and deactivation of the components of coolant subsystem 25.

A direction of circulation of the coolant is shown by arrows 57a, 57b, by way of example. The coolant circulating circuit 50 may exchange heat with the fuel cell stack 22 via a heat exchanger 51, as shown schematically in FIG. 2B. The temperature of the fuel cell stack 22, and of the entire fuel cell system 20, can thereby be reduced as the coolant circulating loop 50 is operating to cool down the fuel cell stack 22.

The coolant circulating circuit 50 comprises a heat exchanger 54 such as e.g. a radiator of the vehicle 10 that allows an air-to-liquid heat exchange for cooling the coolant flown in the loop 50. Thus, as the heat exchanger 54 has the coolant passing therethrough, with assistance of a flow distribution device such as e.g. a fan 56, the temperature of the coolant can be reduced due to heat exchange with a colder outside/ambient temperature. In this way, the coolant circulating circuit 50 can operate to cool the temperature of the coolant due to an exchange with the ambient air in the outside environment.

Furthermore, as shown in FIG. 2B, in some examples, the coolant circulating circuit 50 comprises a bypass path or conduit 58 to which the coolant can be diverted as part of the coolant temperature control. For example, during a start-up of the vehicle, it may be required to increase a temperature of the coolant, and, in such cases, a valve 61 can be operated to move to a position in which the coolant is directed through the bypass conduit 58 rather than towards the heat exchanger 54. The valve 61 is a three-way proportional valve in this example, and it is configured to control the flow of the coolant so that the coolant selectively enters the bypass conduit 58. The bypass conduit 58 may include components, e.g. a heater, not shown in FIG. 2, that allow increasing the temperature of the coolant. Also, the cooling subsystem 25 may have various other additional components, as the specific configuration is shown in FIG. 2B by way of example only.

Regardless of its specific implementation, the cooling subsystem 25 in accordance with examples of the present disclosure may not perform cooling to below the ambient temperature. In some examples, the cooling subsystem 25 may perform cooling to only as low as a few degrees Celsius, e.g., from 1 to 5° C., above the ambient temperature. The coolant may be flown through the bypass conduit 58, by controlling the valve 61 which is controlled to allow the coolant to flow into the bypass conduit 58. The coolant can flow through the bypass conduit 58, e.g. if there is a heater in the bypass conduit 58, when the fuel cell system is turn on e.g., during a warm-up of the fuel cell system.

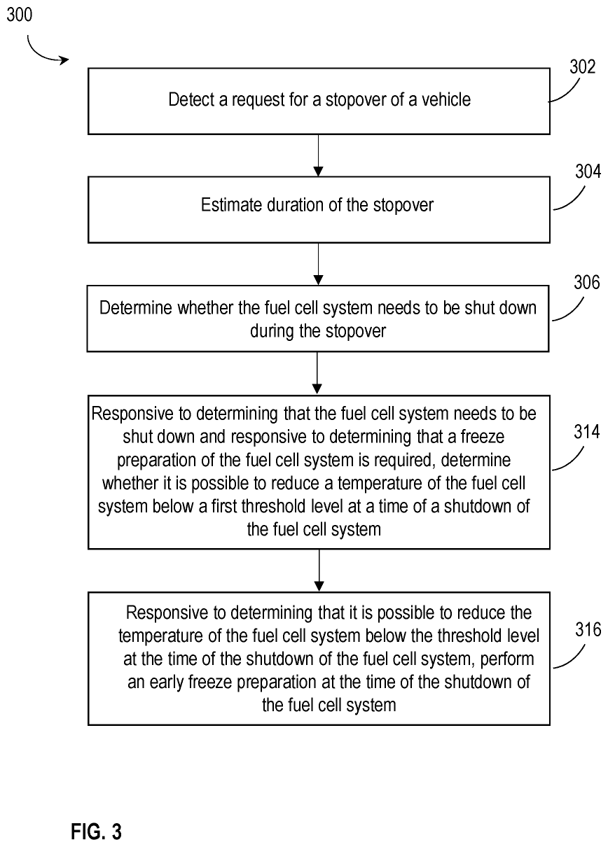

FIG. 3 illustrates an example of a method or process 300 of controlling operation of a fuel cell system of a fuel cell vehicle such as the vehicle 10 of FIGS. 1A and 1B. The method or process 300 may be a computer-implemented method performed by processing circuitry of a control device or system such as e.g. processing circuitry 32 of the control system 30, processing circuitry 37 of the vehicle controller 35, or processing circuitry of the main controller 45 shown in FIGS. 1A, 1B, and 2A.

The process 300 may begin, e.g., at block 302, when a request for a stopover of the vehicle is detected as the vehicle is driving e.g. performing a mission. The request to stop and park the vehicle may be received or detected, e.g., when vehicle is stopped and an indication is received that the vehicle is parked. For example, the vehicle may be keyed off. The parking brakes, such as e.g. electronic parking brakes, may be activated or enabled. A stop or stopover of the vehicle is considered to begin at the point in time when the request for the stopover and/or parking of the vehicle is detected. As used herein, the vehicle stopover is equivalent to the parking of the vehicle. A traction electric machine of the vehicle, such as electrical machine 64, is not operating during the vehicle stopover/parking. One or more of other electric components of the vehicle 10 may be operational. It should be noted that, when the vehicle is stopped/parked, the fuel cell system can either be running or shut down. For example, even in cases when the driver is not in a vehicle cabin and the vehicle is parked for e.g. days, the fuel cell system and/or other components and subsystems in the vehicle may be operating or woken up to perform certain functions, e.g., to ensure that batteries are not discharged. It should be noted that, in some cases, some electric machines of the vehicle may not be shut off and may continue operating during the stopover of the vehicle. In some cases, one or more auxiliary power take-off devices may require power during the stopover of the vehicle. For example, a concrete mixer vehicle, even if parked, will need power for uninterrupted operation of concrete mixing. Various other systems, such as a refrigerator, air conditioning, heating, etc. may continue their operation during the vehicle stopover. Also, the vehicle may be used by a driver, and/or another person, and such person(s) may be sleeping or be in general present in the vehicle. In such cases, certain auxiliary devices of the vehicle may need to be turned on and/or remain to be on, continuously or at certain points during the stopover/parking of the vehicle, e.g. an air conditioning system, a heater, an entertainment system, a lighting system, a wireless communication system, etc.

When the vehicle is parked, the fuel cell system may continue operating for a certain duration of time, or in some examples during the entire duration of the parking of the vehicle. A shutdown and start-up or restart of the fuel cell system may be controlled independently of a control of the vehicle, though the operation of the fuel cell system depends on a load which decreases greatly when the vehicle stops moving. The vehicle may receive power during the parking from its electric storage system energy storage (ESS), and/or from a combination of the fuel cell system and the ESS.

The request for a vehicle stopover/parking may be an actual stopover or a predicted stopover. The actual stopover may be detected e.g. based on receiving a driver input instructing the vehicle to stop. In some circumstances, the vehicle may be expected to stop at a certain location and/or at a certain time, e.g. for a driver's scheduled rest or for another reason, and the request for a stopover may be generated automatically, based on one or more out of a current location of the vehicle, a current time, and other factors.

At block 304, the process 300 comprises estimating a duration of a stopover of the vehicle when the request for the stopover of the vehicle is detected. The duration of the stopover, i.e. for how long the vehicle is expected to be stopped, i.e. parked, before it is started again, may be determined or estimated based on one or more out of a current location of the vehicle, historical data related to operation of the vehicle, historical data on driver behaviour, historical data on other events, current and predicted ambient conditions, a time of the day, driver input, and other type of data.

The historical data related to operation of the vehicle and a pattern of driver behaviour may indicate that the vehicle is used for a certain mission at certain times of the day, while at other times, e.g., at night, the vehicle is parked. For example, from the history of operating the vehicle, it may be known that, at the current location, the vehicle is typically parked for a certain amount of time. It may be known, for example, that the vehicle is typically parked overnight at the current location. As another example, it may be known that the driver has a scheduled break or rest at a certain location for a certain duration of time. Also, depending on a type of the vehicle, e.g., a taxi, a public transportation vehicle, a long haul vehicle, etc., the vehicle may experience different start-stop patterns that may be predicted based on previous use of the vehicle and previously logged data. In some cases, the vehicle may be a sleeper truck or tractor, e.g., a long-haul truck. The vehicle may be a heavy-duty vehicle, e.g., performing a mission, and a driver of the heavy-duty vehicle may be sleeping in that vehicle during stops and/or overnight. In should be appreciated that sleeping may include resting or other status during a stopover of the vehicle.

As another factor, in some cases, driver shifts and laws stating how long drivers can be on the road and/or for how long they are required to take breaks may be taken into consideration in determining a time and duration of a vehicle stopover, which may be different for different vehicle types and different missions. For example, in some cases, the driver may be instructed to make a stop for a certain duration of time, e.g., for a mandatory break. An instruction may be communicated to the driver via the vehicle dashboard or console, or via another device through which the driver is communicating, e.g., with a fleet operator if the vehicle is part of the fleet of vehicles. The driver may then provide an input to the vehicle explicitly indicating for how long the vehicle will be stopped, which is communicated to a vehicle control system, such as one or more out of the control system 30, vehicle control system 35, and the main controller 45.

In some examples, an explicit input indicating a duration of the vehicle stopover may be received from the driver via e.g. an input device of the vehicle or a device capable of communicating with the vehicle, the input indicating for how long the vehicle is expected to be stopped. The input device may be, e.g., provided by a display device that can receive input, such as, e.g., a touch input, keyboard input, voice input, input from various other input devices, etc., from a user such as the driver. The display device may be located in various locations of the vehicle, e.g., on a dashboard or center console. In some embodiments, the display device may be a display of a mobile device of a user such as the driver, and driver input received via such display device may be received remotely, while the driver is not necessarily in proximity to the vehicle. For example, an application or app executing on a driver's mobile device may be configured to receive driver's input regarding the length of the stopover. Any other type of device may be used to receive an input from a driver, or other person, regarding a duration of the vehicle stopover.

The duration of the vehicle stopover may be determined in various other ways.

The duration of the stopover of the vehicle may be in the form of a time until the next (re) start of the vehicle, an actual duration of the stopover, or a time of the next (re) start of the vehicle. The vehicle is started when its electric machine is activated to provide providing propulsion power to move the wheels of the vehicle and thereby allowing the vehicle to drive.

At block 306, it is determined whether the fuel cell system needs to be shut down during the stopover. The determining is based at least on the duration of the stopover of the vehicle. The fuel cell system may need to be shut down in response to various factors, including one or more of the duration of the stopover, an ambient temperature at the stopover location, a status of the fuel cell system of the vehicle, power needs from the fuel cell system during the vehicle stopover, and other factors. For example, if the stopover of the vehicle is expected to be longer than a certain threshold duration the fuel cell system may need to be shut down. As another example, if the ambient temperature during the stopover is expected to be below a certain threshold temperature, the fuel cell system may be kept operational to prevent it from freezing or from a damage that may be caused by a subsequent freeze start-up. At the same time, depending on the length of the stopover period, the fuel cell system may still be shut down and freeze preparation may be performed-before, after, or simultaneously with the fuel cell system shutdown. Various other approaches may be used additionally or alternatively.

At block 314, the control system, responsive to determining that the fuel cell system needs to be shut down during the stopover and responsive to determining that a freeze preparation of the fuel cell system is required during the stopover, determines whether it is possible to reduce a temperature of the fuel cell system below a first threshold level at a time of a shutdown of the fuel cell system. The temperature of the fuel cell system 20 may reflect a temperature of the fuel cell stack 22 as well as of other components of the fuel cell system 20, and the temperature depends on a temperature of a coolant circulating in the cooling subsystem of the fuel cel system and on the ambient temperature. As described above, the coolant, cooled via the ambient environment, is supplied to the fuel cell system to thereby cool the fuel cell system. The temperature of the fuel cell system 20, as used herein, may be measured using sensor measurements acquired from one or more temperature sensors in or associated with the fuel cell system 20. A type and positions of the temperature sensors may depend on an implementation or configuration of the fuel cell system.

In some examples, the first threshold level may be a predetermined i.e. a set in advance temperature threshold which may depend on manufacturing characteristics of the fuel cell system. In some examples, the first threshold level may be adjustable. In some examples, the first threshold level may be set by the control system dynamically e.g., based on an estimation of how many occurrences of the freeze preparation the fuel cell system has undergone and how many of these occurrences have been successful. For the occurrences that have failed, it may be analyzed, e.g., by control system, at what temperature and under which conditions they were performed, etc. Thus, historical data on freeze preparations may be acquired and analyzed, and the first threshold level may be adjusted based on the analysis of such historical data.

In some examples, the first threshold level may be set by the control system based on a state of health (SoH) of the fuel cell system, which is defined herein as a percentage of the remaining lifetime of the fuel cell system, with a 100% SoH indicating a fuel cell system with a 100% remaining lifetime and a 50% SoH indicating a fuel cell system with a 50% remaining lifetime. For example, as the remaining lifetime of the fuel cell system decreases, the first threshold level may be set to a lower value.

The first threshold level defines a temperature of the fuel cell system that is sufficiently low to carry out a freeze preparation of the fuel cell system against a possible damaging effect of below-zero ambient conditions. In some climates, the temperatures may fall well below 0° C., e.g. under −20° C., and the freeze preparation thus becomes essential to adequately protect the fuel cells from damage.

The determining, at block 314, of whether it is possible to reduce the temperature of the fuel cell system below the first threshold level at the time of the shutdown may be performed in dependance on an actual, i.e. current, and/or a predicted ambient temperature. The ambient conditions include at least the ambient temperature, possibly in combination with a speed of wind which can reduce the actual ambient temperature.

In some examples, the determining of whether it is possible to reduce a temperature of the fuel cell system below the first threshold level during the stopover is based on a predicted and/or current ambient temperature and/or a thermal model of the fuel cell system.

In some examples, whether the freeze preparation is required is determined using a thermal model of the fuel cell system and evaluating a heat loss to the surrounding environment, which is a function of an ambient temperature. The thermal model may be, for example, a validated, one-dimensional or multi-dimensional thermal model calculating individual fuel cell temperatures. A need for a freeze preparation may be evaluated by determined end-cell temperatures within the fuel cell stack, i.e., the temperatures of individual fuel cells at the endplates of the fuel cell stack, which may reach freezing temperatures sooner than other cells within the fuel cell system. Alternatively, in some examples, a lumped stack model may be used and a mass-average fuel cell stack temperature may be determined to evaluate a need for freeze protection.

The thermal model may, for example, operate based on an ambient temperature input from a predictive weather service, a measured ambient temperature input taken from a temperature sensor external to the fuel cell system, or a measured temperature input taken from a temperature sensor internal to the fuel cell system, e.g., within the coolant loop. In some cases, the thermal model may be generated as described in, e.g., Henao, N., et al. (“PEMFC low temperature startup for electric vehicle,” IECON 2012-38th Annual Conference on IEEE Industrial Electronics Society, 2012, pp. 2977-2982), Amamou, A., et al. (“Thermal Management Strategies for Cold Start of Automotive PEMFC,” 2015 IEEE Vehicle Power and Propulsion Conference (VPPC), 2015, pp. 1-6), and Khandelwal, M., et al. (“One-dimensional thermal model of cold-start in a polymer electrolyte fuel cell stack,” Journal of Power Sources, 2007, vol. 172, pp. 816-830). In Henao, N., et al. (2012), an energy management strategy using a lumped mass fuel cell stack thermal model is proposed and experimentally validated. The strategy estimates the ideal time to begin heating a fuel cell stack during a cold start operation assuming a known initial fuel cell temperature. A similar lumped model can be used to also estimate the time at which the fuel cell stack would reach a critical temperature, as is done, e.g., in Amamou, A., et al. (2015), where such a model is created to compare cold start strategies. In certain implementations, a model as described in Khandelwal, M., et al. (2007), which simulates individual cell behavior in a one-dimensional transient model, may be used. Any other suitable thermal model of the fuel cell system may be used additionally or alternatively.

In some examples, the determining of whether it is possible to reduce the temperature of the fuel cell system below the first threshold level at the time of the shutdown may be performed in dependance on determining whether the ambient temperature at the time of the fuel cell system shutdown or shortly thereafter, e.g. within a maximum of one hour from the shutdown, may be or may fall below a certain second threshold level. The second threshold level may depend on properties of the fuel cell system, e.g., properties of a cooling subsystem of the fuel cell system. The control system such as e.g. the control system 30 may determine whether the ambient temperature e.g. within a maximum of one hour from the shutdown, is below or is about to fall below the certain threshold level. For example, if the nighttime is approaching and the outside temperature is decreasing rapidly, the ambient temperature may become sufficiently low to allow the temperature of the fuel cell system to become sufficiently low and thus suitable for the freeze preparation procedure.

A fuel cell system operates at temperatures well above the ambient temperature, e.g., in a range of from about 50° C. to about 90° C. In some examples, the temperature of the fuel cell system may be in the range of from about 55° C. to about 85° C. or from about 55° C. to about 75° C. In some examples, a temperature of the fuel cell system may be about 80° C. In some examples, the temperature of the fuel cell system may be up to about 80° C. In some examples, the temperature of the fuel cell system may be up to about 90° C. Thus, at the beginning of the vehicle stopover/parking, the temperature of the fuel cell system will typically be above an ambient temperature and excessively high to perform a freeze preparation. At the same time, the present method allows, if that is feasible based on the ambient temperature, reducing the temperature of the fuel cell system and performing a freeze preparation early i.e. in advance, which in some cases may be before the freeze preparation is actually required.

The cooling subsystem 25 of the fuel cell system 20, adapted and configured to cool the fuel cell system based on the ambient temperature, may only be able to cool the fuel cell system 20 up to or slightly, i.e. from 1 to 5° C., above the ambient temperature. Accordingly, it may be determined that it is possible to reduce the temperature of the fuel cell system below the first threshold level at the time of the shutdown only if the current—at the time of the shutdown or shortly thereafter—ambient temperature is below a certain second threshold level. The second threshold level may be, for example, a temperature in a range of from about 0° C. to about 10° C., or a range of from about 0° C. to about 5° C., or a range of from about 5° C. to about 10° C. In some examples, the second threshold level may be about 0° C. or about 1° C. or about 2° C. or about 3° C. or about 4° C. or about 5° C. or about 6° C. or about 7° C. or about 8° C. or about 9° C. or about 10° C.

Unless specifically stated or obvious from context, as used herein, the term “about” is understood as within a range of normal tolerance in the art, for example within 2 standard deviations of the mean of a stated value. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, as used herein, reducing the temperature of the fuel cell system at the time of the shutdown of the fuel cell system indicates that the temperature reduction is initiated at the time of the shutdown, though the temperature may actually become to be below the first threshold level at a certain time after the fuel cell system has been shut down. Once the fuel cell system has been shut down, i.e. the supply of one or both air and hydrogen to the stack is ceased, and/or the fuel cell system is disconnected from the load, the temperature of the fuel cell system begins to reduce to eventually become to be below the first threshold level, that is, if this is possible based on current and/or predicted ambient conditions. In circumstances in which the actual temperature is equal to or close to, e.g., within a range of from about 0° C. to about 5° C., the second threshold level, assuming the actual temperature remains the same or decreases, the temperature of the fuel cell system may relatively quickly reduce to below the first second threshold level. In this way, the freeze preparation may be performed at a time that is considered to be the time of the fuel cell system shutdown.

In some examples, the second threshold level indicating a temperature threshold for the ambient temperature below which the cooling subsystem 25 is capable of cooling the fuel cell system 20 below a temperature of the first threshold level. In some examples, the second threshold level may be different from the first threshold level. For example, in some examples, the second threshold level may be smaller than the first threshold level, such that the ambient temperature will need to be lower than the temperature, defined herein as the first threshold level, below which the fuel cell system needs to be cooled to make it possible to perform its freeze preparation. In some implementations of the fuel cell system, it may be required that the second threshold level is lower than, i.e. not equal to, the first threshold level.

At block 316, responsive to determining that it is possible to reduce the temperature of the fuel cell system below the first threshold level at the time of the shutdown, the control system performs an early freeze preparation at the time of the shutdown of the fuel cell system. The early freeze preparation is thus performed due to the appropriate circumstances such as ambient conditions, even though the freeze preparation may not yet be required due to the ambient temperatures not being sufficiently low, e.g., below freezing, to create concerns regarding a risk of damage to the fuel cell system due to freezing. At that point, the control system performs a shutdown of the fuel cell system, reduces the temperature of the fuel cell system below the threshold level, and performs the freeze preparation.

It should be noted that, even though a freeze preparation may cause certain damage to the fuel cell system, since it is already determined to be required during the stopover/parking of the vehicle, the early freeze preparation does not bear any unnecessary damaging effect on the fuel cell system. Indeed, instead of postponing the freeze preparation until ambient conditions so allow, which requires keeping certain components of the control system operational, the early freeze preparation is carried out in advance. In this way, certain components of the control system, e.g., one or more monitoring units, may be deactivated and advantageously no further monitoring of the fuel cell system may be required until the vehicle is restarted once the stopover is terminated. This allows saving energy costs and thereby improving the efficiency of operating the fuel cell system in the vehicle. One or more components of the vehicle, other than the control system(s), may also be reactivated or deactivated when the early freeze preparation is performed, thereby eliminating a need to monitor the fuel cell system and surrounding conditions regarding a potential wake-up of the fuel cell system from a shutdown. The fuel cell system freeze preparation requires operational high voltage (HV) of the fuel cell vehicle. Thus, the early freeze preparation allows avoiding a waste of the energy that would otherwise be required to subsequently wake up the fuel cell system, activate component(s) of the HV system, and perform the freeze preparation. In addition, at the fuel cell system shutdown, fuel cell system conditions may be more controllable as compared to a subsequent wake-up of the fuel cell system after it has been shut down.

Furthermore, even though in some existing systems water can be removed from the fuel cell system at a fuel cell system shutdown, as part of freeze preparation, in examples of the present disclosure, the freeze preparation is performed only based on the determining that it is possible to reduce the temperature of the fuel cell system below the first threshold level at the time of the shutdown. Thus, rather than always performing some form of freeze protection at a fuel cell system shutdown, it is done only if the cooling subsystem of the fuel cell system is able to, given the current ambient temperature, reduce the temperature of the fuel cell system below the first threshold level at the time of the shutdown.

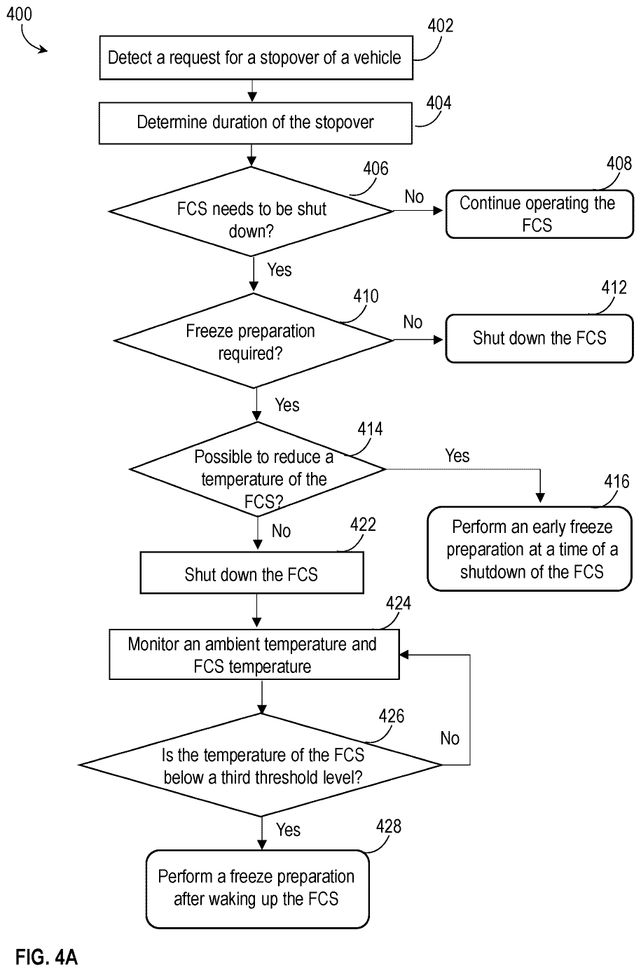

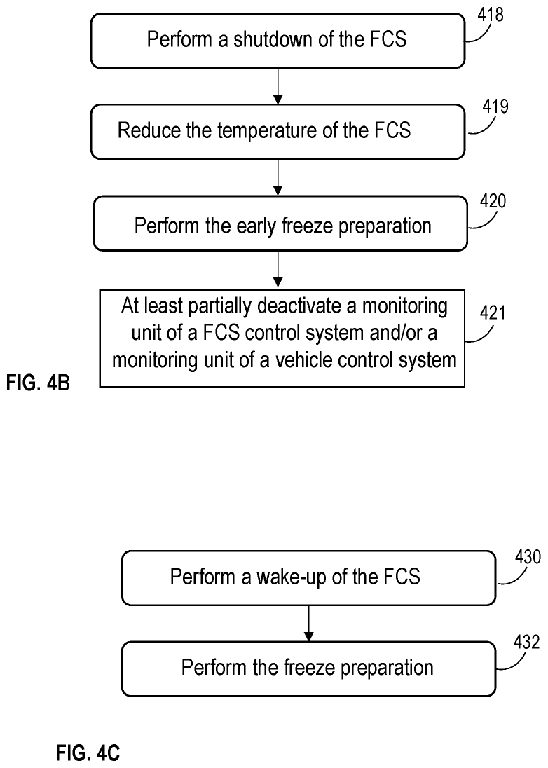

FIGS. 4A, 4B, and 4C illustrate an example of a method or process 400 of controlling operation of a fuel cell system (FCS) of a fuel cell vehicle such as the fuel cell system 20 of the vehicle 10. The method or process 400 includes acts or steps similar to process 300 the description of which therefore applies to the process 400 and is not repeated in connection with FIGS. 4A, 4B, and 4C. The method or process 400 further illustrates the method of controlling operation of a fuel cell system in accordance with an example of the present disclosure. The method or process 400 may be a computer-implemented method performed by processing circuitry of a control device or system such as e.g. the control system 30, the vehicle controller 35, or the main controller 45 shown in FIGS. 1A, 1B, and 2A.

At block 402 of FIG. 4A, a request for a stopover or parking of the vehicle is detected. The request for the stopover, i.e. to stop/park the vehicle, may be received or detected, e.g., when the vehicle is stopped and the vehicle's parking brakes are activated. The processing at block 402 is similar to the processing at block 302 of FIG. 3.

At block 404, the process 400 comprises estimating a duration of the stopover of the vehicle when the request for the stopover of the vehicle is detected. The processing at block 404 is similar to the processing at block 304 of FIG. 3.

At decision block 406, the control system determines whether the fuel cell system needs to be shut down during the stopover. The processing at block 406 is similar to the processing at block 306 of FIG. 3. The determining is based at least on the duration of the stopover of the vehicle. Furthermore, the fuel cell system may not need to be shut down when there are energy/power needs, referred to herein as power needs, from the fuel cell system during the vehicle stopover, and such power needs cannot be fulfilled by the ESS of the vehicle during the vehicle stopover, such that the fuel cell system needs to remain operational to generate power in accordance with the power needs.

The power needs may be estimated using one or more of ambient conditions, duration of the vehicle stopover as determined at block 404, information on vehicle auxiliary devices that are turned on and/or expected to be turned on during the vehicle stopover, historical data on usage of the vehicle auxiliary devices, and using other data. For example, in cases in which the duration of the vehicle stopover is sufficiently short, it may not be needed to shut down the fuel cell system.

The power needs for a duration of the vehicle stopover may include power needs for power take-off (PTO) devices connected to or installed on the vehicle, such as, e.g., a crane, a refrigerator, an air conditioner, a heater, etc.

At block 408, responsive to determining that the fuel cell system does not need to be shut down (“No”) during the stopover of the vehicle, the control system operates to continue operating the fuel cell system 20. For example, the fuel cell system may continue generating power to fulfill power needs of the vehicle during the stopover.

At decision block 410, responsive to determining that the fuel cell system needs to be shut down (“Yes”) during the stopover, the process 400 comprises determining whether a freeze preparation of the fuel cell system is required during the stopover. This may be determined using data on a current ambient temperature and/or predicted ambient temperature. For example, if it is expected that an ambient temperature, i.e. an external temperature or weather, or a temperature in another environment in which the vehicle is located, falls below 0° C. during the vehicle stopover, it may be determined that the freeze protection is required. It may also be considered for how long the ambient temperature is expected to be below 0° C. Thus, in some examples, the freeze protection may not be required if the ambient temperature is not expected to fall below 0° C. In some examples, the freeze protection may not be required if it is expected to fall below 0° C. for a time period that is not expected to create a risk associated with freezing conditions.

The predicted ambient conditions may be received, e.g., from weather prediction services. For example, the control system may receive information, via a wireless communications network, on a weather forecast indicating that the ambient temperatures will fall below 0° C. during the time the vehicle is expected to remain to be shut down at the current location, i.e. during the stopover of the vehicle. Also, current ambient temperature, which may be determined using, e.g., one or more sensors associated with the vehicle, may be used in determining whether it is required to perform the freeze preparation of the fuel cell system during the stopover of the vehicle.

In some examples, determining whether the freeze preparation of the fuel cell system is required or not is based on the ambient temperature and/or a thermal model of the fuel cell system. The ambient temperature may be a predicted and/or current ambient temperature. In some examples, whether the freeze preparation is required is determined using a thermal model of the fuel cell system and evaluating a heat loss to the surrounding environment, which is a function of an ambient temperature. Thermal models were discussed above, in connection with block 314 (FIG. 3), and similar one or more thermal models of the fuel cell system may be used.

At block 412, responsive to determining that the freeze preparation of the fuel cell system is not required (“No”) during the stopover of the vehicle, the fuel cell system may be shut down. The freeze preparation of the fuel cell system may not be required, for example, when the ambient temperature of the environment outside the vehicle is not expected to fall below a certain temperature threshold. In some examples, this temperature threshold is about 0° C. In some cases, the vehicle may be parked indoors and in such conditions no freeze preparation may be required.

At decision block 414, responsive to determining that the freeze preparation of the fuel cell system is required (“Yes”) during the stopover of the vehicle, the process 400 comprises determining whether it is possible to reduce the temperature of the fuel cell system below the first threshold level at the time of the shutdown of the fuel cell system. The processing at block 414 is similar to the processing at block 314 of FIG. 3.

In some examples, the determining of whether it is possible to reduce a temperature of the fuel cell system below the first threshold level during the stopover is based on a predicted and/or current ambient temperature and/or a thermal model of the fuel cell system, e.g. as discussed in connection with block 314 of FIG. 3.

In examples herein, it is generally determined whether the freeze preparation may be performed early, i.e. at the time of the shutdown of the fuel cell system, or whether the freeze preparation is to be subsequently performed. For the freeze preparation to be performed subsequently, at least some functions of the control system will need to remain activated to monitor a temperature of the fuel cell system and/or an ambient temperature and be able to wake up the fuel cell system, and one or more other components of the vehicle, when one or both the ambient temperature and the temperature of the fuel cell system are indicative of conditions suitable for a freeze preparation of the fuel cell system.

At block 416, responsive to determining that it is possible (“Yes”) to reduce the temperature of the fuel cell system below the first threshold level at the time of the shutdown of the fuel cell system, the control system performs an early freeze preparation of the fuel cell system at the at the time of the shutdown of the fuel cell system. In other words, an early freeze preparation is performed while shutting down the fuel cell system. FIG. 4B, discussed below, illustrates separately the processing that is performed for the early freeze preparation of the fuel cell system.

Alternatively, at block 422, responsive to determining that it is not possible (“No”) to reduce the temperature of the fuel cell system below the first threshold level at the time of the shutdown of the fuel cell system, the fuel cell system is shut down without performing the freeze preparation. The control system controls performance of the shutdown of the fuel cell system 20, which may be performed in various ways, depending on a configuration of the fuel cell system and other factors.

At block 424, the control system monitors an ambient temperature and a temperature of the fuel cell system 20 during the stopover of the vehicle, with the fuel cell system being shut down. The temperatures are monitored to determine whether to wake up the fuel cell system to subject it to a freeze preparation. The temperatures may be monitored in real time. The one or both of the ambient temperature and the fuel cell stack temperature may be monitored continuously. In some examples, the control system may acquire measurements from one or more temperature sensors periodically e.g. at certain time intervals. For example, a suitable component, e.g., a monitoring unit, of the control system, may wake up e.g. very few minutes or very few hours to detect if the temperature have dropped below a threshold or not.

The ambient temperature may be monitored by the control system via one or more temperature sensors installed on the vehicle or in association with the vehicle. Also, in addition to alternatively, the control system may receive current and predicted weather information from a remote weather service, e.g. via a wireless communications network. In some locations, the control system may receive information from a local weather hub that may be configured to wirelessly communicate with the control system to provide to the control system data on a current temperature at the location. The temperature of the fuel cell stack may be measured by a sensor positioned to acquire and communicate the temperature of the fuel cell stack. Regardless of the specific way in which the ambient temperature and the temperature of the fuel cell stack are monitored, the control system employs these measurements to determine whether to wake up the fuel cell system. In some examples, additionally, a temperature of a coolant flowing in the cooling subsystem may also be monitored.

At decision block 426, the control system determines, based on the temperature monitoring at block 424, whether the temperature of the fuel cell system is, or is expected to become, below a third threshold level. The determining is performed to assess whether the conditions have become to be appropriate for performing a freeze preparation.

During a stop of the vehicle, the temperature of the fuel cell system, due to natural cooldown, may fall to below the third threshold level. The third threshold level may be different than the first threshold level. In some examples, the third threshold level may be lower than the first threshold level. In some examples, the third threshold level may be greater than the first threshold level. Furthermore, in some examples, the third threshold level may be the same as the first threshold level.

Furthermore, in some examples, the processing at block 426 comprises determining, based on the monitored temperatures, that one or both the ambient temperature and the temperature of the fuel cell system are indicative of the conditions appropriate for performing the freeze preparation for the fuel cell system. For example, the ambient temperature, actual and/or predicted, may be such that the temperature of the fuel cell system is soon to decrease to below the third threshold level. For example, if the ambient temperature is below or close to the second threshold level discussed above, it may be indicating that the temperature of the fuel cell system is about to become to be below the third threshold level. It should be noted that, after the shutdown of the fuel cell system, the temperature of the fuel cell system may decrease only due to a natural cooling, i.e. heat loss due to the temperature gradient arising because of the decreased ambient temperature.

In some examples, the third threshold level may be the same as the second threshold level. In some examples, the second threshold level may be lower than the third threshold level. Thus, the ambient temperature will need to a lower temperature than a temperature that is required for the fuel cell system to be in conditions for the freeze preparation.

Responsive to determining at block 426 that the temperature of the fuel cell system is not below (“No”), e.g. greater than, or in some cases equal to, the third threshold level, the process 400 may return to block 424 where the ambient temperature and the temperature of the fuel cell system continue to be monitored by the control system. In other words, until it is detected that the fuel cell system has a temperature below the third threshold level, the control system continues acquiring temperature sensor measurements to assess the current conditions. It should be noted that the ambient temperature and the temperature of the fuel cell system may be monitored in other circumstances as well, including during a normal operation of the fuel cell system. Here, these temperatures are monitored to determine whether and when to wake up the fuel cell system and perform a freeze preparation.

The ambient temperature, both actual and predicted, may be used to identify when the control system should wake up next time and perform the fuel cell system temperature check. In this way, the control system does not always have to be fully active, and a continuous monitoring can be avoided. Thus, in some cases, the process 400 returns to processing at block 424 less frequently, and the processing at block 424 does not have to be performed continuously.

The processing at blocks 424 and 426 may continue until either it is detected that the temperature of the fuel cell system becomes below the third threshold level or until the end of the stopover of the vehicle. In other words, the vehicle starts again at the end of the stopover. In some cases, the stopover of the vehicle may be terminated before a predicted time of the next start of the vehicle. In some cases, the vehicle may be started before or after the stopover period, as estimated at block 404, has expired. If the vehicle stopover is interrupted, e.g., in response to an input from the driver indicating a start of the vehicle leading to a start of the fuel cell system before an expected start time, the duration of the vehicle stopover becomes, or is set to, zero, and the stopover period is considered expired. In some cases, the start of the vehicle may not lead to the start of the fuel cell system. For example, when the vehicle only needs to be moved a short, e.g., a few hundred meters, distance, e.g., to change its parking position, there may be no need to start the fuel cell system. The start of the vehicle may not lead to the start of the fuel cell system in other circumstances. When the fuel cell system is not started up, its temperature is not increased, and there may still exist a possibility of freezing.

At block 428, in response to determining at block 426 that the temperature of the fuel cell system is below (“Yes”) the third threshold level, the control system performs a process that is referred to as performing a freeze preparation after waking up the fuel cell system. FIG. 4C, discussed below, illustrates separately the processing that is performed for the freeze preparation after waking up the fuel cell system.

FIG. 4B illustrates an example of the processing, at block 416 of FIG. 4A, that is performed for the early freeze preparation of the fuel cell system, i.e. a freeze preparation carried out a time of a shutdown of the fuel cell system.

At block 418, the shutdown of the fuel cell system is performed. This may be performed in any of various ways suitable for the fuel cell system. A sequence of steps may be followed as the control system instructs the fuel cell system to shut down. As a result of the shutdown, the fuel cell system stops generating power and heat, such that the temperature of the fuel cell stack, and of other components of the fuel cell system, begins to decrease.

At block 419, the temperature of the fuel cell system is reduced below the first threshold level. As discussed above, the temperature is reduced using the cooling subsystem that can only reduce the temperature of the fuel cell system to a level of the ambient temperature. A further reduction, below the ambient temperature, is not possible with the cooling subsystem of the fuel cell system 20 described herein.

At block 420, the freeze preparation is performed after the fuel cell system had been shut down and cooled to below the first threshold level. The freeze preparation may be any suitable technique that makes the fuel cell system 20 resilient to freezing conditions. In some examples, residual water is removed from the fuel cell stack 22 of the fuel cell system 20. For example, in some cases, one or more media may be circulated through the fuel cell stack 22 to remove residual moisture from the stack. As an example, water in the fuel cell stack may be purged by pushing it out using an air flow at the cathode side and/or hydrogen flow at the anode side. Other techniques may be used to remove moisture from the fuel cell stack 22. In this way, a risk of degradation and damage of the fuel cell system due to freezing of the water, which may otherwise remain in the fuel cell system when it is shut off, is advantageously reduced.

At block 421, the control system may at least partially deactivate a monitoring unit of a fuel cell control system and/or a monitoring unit of a vehicle control system. In some examples, the monitoring unit 34 of the control system 30 and/or the monitoring unit 36 of the vehicle control system 35 may be at least partially deactivated, thereby saving energy required to operate one or both of the control systems 30, 35, which advantageously allows saving energy costs. In some cases, once the early freeze preparation is performed, such that fuel cell system 20 is adequately protected from a damaging effect of freezing conditions expected during the vehicle stopover, no further monitoring of conditions, e.g. a temperature, of the fuel cell system 20 may be required. In some examples, the control system 30, which may be part of the main controller 45, may be configured to at least partially active/deactivate the vehicle controller 35 itself and/or partially activate/deactivate certain functions or components of the vehicle 10. Depending on a specific configuration and control of the vehicle, energy savings may be achieved from one or both partial deactivation, or partial activation, of functions of the vehicle controller 35 and partial deactivation, or partial activation, of some components of the vehicle during the parking of the vehicle 10.

In some examples, functions of the fuel cell vehicle that may be deactivated once the early freeze preparation is performed comprise monitoring of the ambient temperature, monitoring of the fuel cell system temperature e.g. if there are any surface temperature sensors, monitoring of a coolant temperature, etc.

FIG. 4C illustrates an example of the processing at block 428 of FIG. 4A, that is performed as part of freeze preparation performed after waking up the fuel cell system that has been previously shut down. As discussed above, the monitoring unit 34 of the control system 30 may remain at least partially active after the shut-off of the fuel cell system 20, to continue monitoring conditions of the fuel cell system and/or ambient conditions. Additionally or alternatively, the monitoring unit 36 of the vehicle system 35 may remain at least partially active during the stopover of the vehicle and when the fuel cell system is shut down, to continue monitoring conditions at and around the fuel cell system 20.

At block 430, when it has been determined that the temperature of the fuel cell system 20 is below the third threshold, as shown at block 426 of FIG. 4A, the control system may perform a wake-up of the fuel cell system 20 during the stopover of the vehicle. The waking up of the fuel cell system may involve waking up or activating one or more out of one or more components of the fuel cell system 20, one or more components of a control system controlling operation of the fuel cell system 20, and one or more components of the vehicle. The control system activates at least functions of the fuel cell system 20 and/or other components of the vehicle 10 that are required to be active for the freeze preparation.

At block 432, the freeze preparation is performed after the wake-up of the fuel cell system, as performed at block 430. The control system controls initiation and performance to completion of the freeze preparation processing.

It should be noted that the processing at blocks of each of FIGS. 3, 4A, 4B, and 4C may be performed in an order that is different from the depicted order, as the order of the actions in the blocks is shown by way of example.

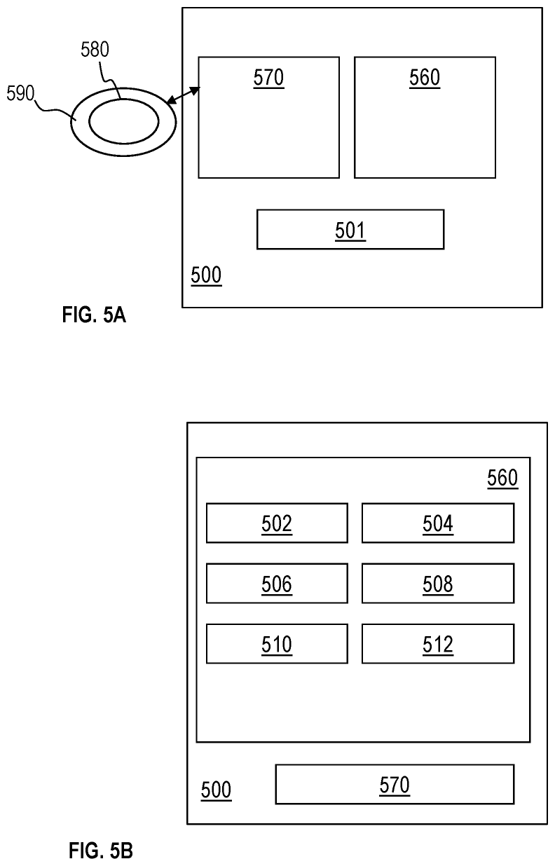

Methods of controlling operation of the fuel cell system as described herein, in accordance with examples of aspects of the present disclosure, may be performed by a control system such as, e.g., one or more of the fuel cell system controller/control system 30, the vehicle controller 35, and the main controller 45 which may in turn be formed by one or more devices or systems. The control system may be part of the fuel cell system or a separate device. FIGS. 5A and 5B additionally illustrate an example of an arrangement of a controller or control system 500 such as e.g., the fuel cell system controller/control system 30, the vehicle controller 35, and/or the main controller 45, for implementing examples disclosed herein. Any one or more of the fuel cell system controller/control system 30, the vehicle controller 35, and the main controller 45 may be implemented as the control system 500 shown in FIGS. 5A and 5B.

As shown in FIG. 5A, the control system 500 in the vehicle 10 comprises processing circuitry 560, memory 570, and an input and output interface 501 configured to communicate with any necessary components and/or entities of examples herein. The input and output interface 501 may comprise a wireless and/or wired receiver and a wireless and/or wired transmitter. In some examples, the input and output interface 501 may comprise a wireless and/or wired transceiver. The control system 500 may be positioned in any suitable location of the vehicle 10. The control system 500 may use the input and output interface 501 to control and communicate with various sensors, actuators, subsystems, and/or interfaces of the fuel cell system and the vehicle 10, by using any one or more out of a Controller Area Network (CAN) bus, ethernet cables, Wi-Fi, Bluetooth, and/or other network interfaces.

The methods described herein may be implemented using processing circuitry, e.g., one or more processors, such as the processing circuitry 560 of the control system 500, together with computer program code stored in a computer-readable storage medium for performing the functions and actions of the examples herein.

The memory 570 may comprise one or more memory units. The memory 570 comprises computer-executable instructions executable by the processing circuitry 560 of the control system 500. The memory 570 is configured to store, e.g., information, data, etc., and the computer-executable instructions to perform, when executed by the processing circuitry 560, the methods in accordance with examples herein. The control system 500 may additionally obtain information from an external memory.

The methods according to the aspects of the present disclosure may be implemented by e.g. a computer program product 580 or a computer program, comprising computer-executable instructions, i.e., software code portions, which, when executed by processing circuitry, e.g., the processing circuitry 560, cause the processing circuitry to perform the actions described herein, as performed by one or more of the control system 30, the vehicle controller 35, or the main controller 45.

In some examples, the computer program product 580 is stored on a computer-readable storage medium 590. The computer-readable storage medium 590 may be, e.g., a disc, a universal serial bus (USB) stick, or similar device. The computer-readable storage medium 590, having stored thereon the computer program product, may comprise computer-executable instructions which, when executed by processing circuitry, e.g., the processing circuitry 560, cause the processing circuitry to perform the actions of the methods in accordance with examples of the present disclosure described herein, as performed by one or more of the control system 30, the vehicle controller 35, and/or the main controller 45.

As shown in FIG. 5B, the control system 500 may comprise an estimating unit 502. The control system 500, the processing circuitry 560, and/or the estimating unit 502 are configured to estimate a duration of a stopover of the vehicle when a request for the stopover is detected. The duration of the stopover may be determined based on one or more out of a location of the vehicle, historical data on operation of the vehicle, and input from a driver of the vehicle.

The control system 500 may comprise a determining unit 504. The control system 500, the processing circuitry 560, and/or the determining unit 504 are configured to determine whether the fuel cell system needs to be shut down during the stopover, wherein the determining is based at least on the duration of the stopover of the vehicle.

The control system 500, the processing circuitry 560, and/or the determining unit 504 are further configured to, responsive to determining that the fuel cell system needs to be shut down during the stopover and responsive to determining that a freeze preparation of the fuel cell system is required during the stopover, determine whether it is possible to reduce a temperature of the fuel cell system below a first threshold level at a time of a shutdown of the fuel cell system. In some examples, the control system 500, the processing circuitry 560, and/or the determining unit 504 may be configured to determine whether it is possible to reduce a temperature of the fuel cell system below the first threshold level during the stopover by determining whether the ambient temperature is below a second threshold level. In some examples, the determining whether it is possible to reduce a temperature of the fuel cell system below the first threshold level during the stopover is based on a predicted and/or current ambient temperature and/or a thermal model of the fuel cell system.

The control system 500, the processing circuitry 560, and/or the determining unit 504 may be configured to determine whether a freeze preparation of the fuel cell system is required or not. This may be done based on a predicted and/or current ambient temperature and/or a thermal model of the fuel cell system.

The control system 500 may comprise a performing unit 506. The control system 500, the processing circuitry 560, and/or the performing unit 506 are configured to, responsive to determining that it is possible to reduce the temperature of the fuel cell system below the first threshold level at the time of the shutdown of the fuel cell system, perform an early freeze preparation at the time of the shutdown of the fuel cell system, by controlling the fuel cell system and other components of the vehicle to perform the early freeze preparation. Performing the early freeze preparation may comprise shutting down the fuel cell system, reducing a temperature of the fuel cell system, and performing the actual freeze preparation.

In some examples, the control system 500, the processing circuitry 560, and/or the performing unit 506 may be configured to perform the shutdown of the fuel cell system. The control system 500, the processing circuitry 560, and/or the performing unit 506 may also be configured to perform the freeze preparation of the fuel cell system.

The control system 500 may comprise a reducing unit 508. The control unit 30, the processing circuitry 560, and/or the reducing unit 508 may be configured to reduce the temperature of the fuel cell system below the first threshold level. In some examples, the temperature of the fuel cell system is reduced below the first threshold level using a cooling subsystem of the fuel cell system.

The control system 500 may comprise a monitoring unit 510 which may be the same or similar to the monitoring unit 34 of the control system 30 and/or monitoring unit 36 of the vehicle control system 35 (FIG. 1B). The control system 500, the processing circuitry 560, and/or the monitoring unit 510 may be configured to monitor an ambient temperature, a temperature of the fuel cell system, and any other parameters, e.g., by acquiring and processing sensor measurement data collected by one or more temperature sensors.

The monitoring unit 510 may acquire sensor data acquired by the control system 500, as well as sensor data and other type of data that may be acquired by the control system 500 from an external source, e.g., from one or more of a remote weather, positioning, and/or other service.

The control system 500 may comprise an activating/deactivating unit 512. The control unit 500, the processing circuitry 560, and/or the activating/deactivating unit 512 may be configured to at least partially deactivate the monitoring unit of the control system 30 of the fuel cell system 20 and/or at least partially deactivate the monitoring unit of the vehicle control system 35 of the fuel cell vehicle, to thereby activate or deactivate certain functions of the fuel cell system and/or the vehicle. For example, the activating/deactivating unit 512 may activate or deactivate functions or components of the fuel cell system related to monitoring the fuel cell system status during the vehicle stopover. The monitoring of the fuel cell system status may include monitoring an ambient temperature, a temperature of the fuel cell system, and any other parameters. For example, the activating/deactivating unit 512 may also activate or deactivate functions or components of the vehicle 10.

In some examples, the control system 500, the processing circuitry 560, and/or the performing unit 506 may be configured to, responsive to determining that it is not possible to reduce the temperature of the fuel cell system below the first threshold level at the time of the shutdown, perform the shutdown of the fuel cell system without performing a freeze preparation.

In some examples, control system 500, the processing circuitry 560, and/or the monitoring unit 510 may be configured to monitor an ambient temperature and a temperature of the fuel cell system, with the fuel cell system being shut down. The control system, the processing circuitry 560, and/or the determining unit 504 may be configured to determine, based on the monitoring, whether the temperature of the fuel cell system is below a third threshold level. The control system 500, the processing circuitry 560, and/or the performing unit 506 may be configured to perform a wake-up of the fuel cell system, and perform the freeze preparation after the wake-up of the fuel cell system.

In some examples, the control system 500 of a vehicle such as, e.g., the vehicle 10, may be implemented as a computer system.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Those skilled in the art will appreciate that the control system 500 and any units that may be present in the control system 500 may refer to a combination of analogue and digital circuits, and/or one or more processors that may be configured with software and/or firmware that, when executed by the respective one or more processors, may carry out the actions or steps of the method(s) in accordance with the present disclosure. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A fuel cell vehicle comprising:
a fuel cell system comprising an anode, a cathode, and a cooling subsystem; and
a control system comprising processing circuitry configured to control operation of a fuel cell system, the processing circuitry being further configured to:
estimate a duration of a stopover of the vehicle when a request for the stopover of the vehicle is detected;
determine whether the fuel cell system needs to be shut down during the stopover, wherein the determining is based at least on the duration of the stopover of the vehicle;
responsive to determining that the fuel cell system needs to be shut down during the stopover and responsive to determining that a freeze preparation of the fuel cell system is required during the stopover, determine whether it is possible to reduce a temperature of the fuel cell system below a first threshold level at a time of a shutdown of the fuel cell system; and
responsive to determining that it is possible to reduce the temperature of the fuel cell system below the first threshold level at the time of the shutdown of the fuel cell system, perform an early freeze preparation at the time of the shutdown of the fuel cell system.

2. The fuel cell vehicle of claim 1, wherein the processing circuitry is further configured to control operation of the fuel cell system such that the performing of the freeze preparation at the time of the shutdown of the fuel cell system comprises:
performing the shutdown of the fuel cell system,
reducing the temperature of the fuel cell system below the first threshold level, and
performing the freeze preparation.

3. The fuel cell vehicle of claim 2, wherein the temperature of the fuel cell system is reduced below the first threshold level using the cooling subsystem of the fuel cell system.

4. The fuel cell vehicle of claim 1, wherein the processing circuitry is further configured to control operation of the fuel cell system by, responsive to determining that it is not possible to reduce the temperature of the fuel cell system below the first threshold level at the time of the shutdown, performing the shutdown of the fuel cell system without performing a freeze preparation.

5. The fuel cell vehicle of claim 4, wherein the processing circuitry is further configured:
monitor an ambient temperature and a temperature of the fuel cell system, with the fuel cell system being shut down;
determine, based on the monitoring, whether the temperature of the fuel cell system is below a third threshold level; and
responsive to determining that the temperature of the fuel cell system is below the third threshold level,
perform a wake-up of the fuel cell system, and
perform the freeze preparation after the wake-up of the fuel cell system.

6. The fuel cell vehicle of claim 1, wherein the processing circuitry is configured to determine the duration of the stopover based on one or more out of a location of the vehicle, historical data on operation of the vehicle, and input from a driver of the vehicle.

7. The fuel cell vehicle of claim 1, wherein the processing circuitry is configured to determine whether a freeze preparation of the fuel cell system is required or not based on a predicted and/or current ambient temperature and/or a thermal model of the fuel cell system.

8. The fuel cell vehicle of claim 1, wherein the processing circuitry is configured to determine whether it is possible to reduce a temperature of the fuel cell system below the first threshold level during the stopover is based on a predicted and/or current ambient temperature and/or a thermal model of the fuel cell system.

9. The fuel cell vehicle of claim 8, wherein the processing circuitry is configured to determine whether it is possible to reduce the temperature of the fuel cell system below the first threshold level during the stopover by determining whether the ambient temperature is below a second threshold level.

10. The fuel cell vehicle of claim 1, comprising a vehicle control system configured to control operation of the fuel cell vehicle.

11. The fuel cell vehicle of claim 10, wherein the control system and the vehicle control system are part of a same control system.

12. The fuel cell vehicle of claim 10, wherein the control system is configured to at least partially deactivate a monitoring unit of the control system and/or at least partially deactivate a monitoring unit of the vehicle control system.

13. A method of controlling operation of a fuel cell system of a fuel cell vehicle, the method comprising:
estimating duration of a stopover of the vehicle when a request for the stopover of the vehicle is detected;
determining whether the fuel cell system needs to be shut down during the stopover, wherein the determining is based at least on the duration of the stopover of the vehicle;
responsive to determining that the fuel cell system needs to be shut down during the stopover and responsive to determining that a freeze preparation of the fuel cell system is required during the stopover, determining whether it is possible to reduce a temperature of the fuel cell system below a first threshold level at a time of a shutdown of the fuel cell system; and
responsive to determining that it is possible to reduce the temperature of the fuel cell system below the first threshold level at the time of the shutdown of the fuel cell system, performing an early freeze preparation at the time of the shutdown of the fuel cell system.

14. The method of claim 13, wherein performing the freeze preparation at the time of the shutdown of the fuel cell system comprises:
performing the shutdown of the fuel cell system,
reducing the temperature of the fuel cell system below the first threshold level, and performing the freeze preparation.

15. The method of claim 14, further comprising at least partially deactivating a monitoring unit of a control system of the fuel cell system and/or at least partially deactivating a monitoring unit of a vehicle control system of the fuel cell vehicle.

16. The method of claim 14, wherein the temperature of the fuel cell system is reduced below the first threshold level using a cooling subsystem of the fuel cell system.

17. The method of claim 13, further comprising, responsive to determining that it is not possible to reduce the temperature of the fuel cell system below the first threshold level at the time of the shutdown of the fuel cell system, performing the shutdown of the fuel cell system without performing a freeze preparation.

18. The method of claim 17, further comprising:
monitoring an ambient temperature and a temperature of the fuel cell system, with the fuel cell system being shut down;
determining, based on the monitoring, whether the temperature of the fuel cell system is below a third threshold level; and
responsive to determining that the temperature of the fuel cell system is below the third threshold level,
performing a wake-up of the fuel cell system, and
performing the freeze preparation after the wake-up of the fuel cell system.

19. (canceled)

20. (canceled)

21. The method of claim 13, wherein the determining whether it is possible to reduce a temperature of the fuel cell system below the first threshold level during the stopover is based on a predicted and/or current ambient temperature and/or a thermal model of the fuel cell system.

22. The method of claim 21, comprising determining whether it is possible to reduce a temperature of the fuel cell system below the first threshold level during the stopover by determining whether the ambient temperature is below a second threshold level.

23-26. (canceled)
